(19) United States
(12) Patent Application Publication
(10) Pub. No.: US 2017/0361176 A1
(43) Pub. Date: Dec. 21, 2017

(54) DEVICE FOR STORING AND DISPENSING SPORTING BALLS

(71) Applicant: Ilan SHERR, Rishon Lezion (IL)

(72) Inventor: Ilan SHERR, Rishon Lezion (IL)

(21) Appl. No.: 15/544,052

(22) PCT Filed: Feb. 4, 2015
(86) PCT No.: PCT/IL2015/050128

§ 371 Date: Jul. 17, 2017

(51) Int. Cl. A63B 47/00; B65G 1/07; A63B 69/40; B65G 1/20; B65G 1/12

(52) U.S. Cl. CPC A63B 47/002; B65G 1/20; B65G 1/12; A63B 69/407; B65G 1/07; A63B 2069/401

(57) ABSTRACT

The present invention provides a ball container utilized in conjunction with existing standard storage bins for storing and dispensing sporting balls to the upper opening of the storage bins. The present invention further provides a ball container utilized by hanging from a stand for storing and dispensing sporting balls to the upper opening of the ball container.

### FIELD OF THE INVENTION

The present invention relates to the field of ball sport accessories, and more specifically, to ball dispensers for dispensing sporting balls as are used in various sports.

### BACKGROUND OF THE INVENTION

All ball sports involve the inherent use of balls of some sort as part of the play. Moreover, many professional and recreational ball players have specific ways to practice the handling of the specific game balls. For example, many tennis players exercise their return shot (forehand, backhand, volley, and etc) techniques with a familiar that serves balls in a consecutive manner while the player trains his abilities to successfully shot the ball in return.

This type of training methods, usually involve large containers for storing and dispensing balls, specific to the sport at matter. Most often than not, these containers are simple and standard bins adapted for storing and dispensing many kinds of movable objects. Other times, there are stands that were designed to serve as a placement for such standard bins that lack the standard bin itself and therefore, miss their purpose.

While serving balls to the trainee the amount of balls in the bin dwindles, and the trainee's familiar is required to bend his back while reaching for the next ball. Furthermore, where there is a small amount of balls in the bin, the balls scatter sporadically within the bottom of the bin. This requires the user to blindly search for a ball before reaching said ball.

It is to be mentioned that even when both bin and stand are available in the courtyard, one must bend his back and lift heavy weights in order to pour said balls into the bin placed upon the stand, or otherwise, place heavy full bins upon the stand.

Followed are several publications in the field that have disclosed devices that try to tackle the abovementioned problem:

U.S. Pat. No. 5,507,541 A describe a wheeled container for retrieving and storing balls with a pair of handles. However, devices by these inventions are bulky to carry around; quite difficult to maneuver once the basket is full; need to be manually elevated to the proper height to obviate the need for back bending; and may not be used with existing standard bins.

US 2006/0228928 A1 describes a container with a platform automatically moving downwards as the receptacle is filled with balls, and automatically moving upwards as the receptacle is emptied of balls in response to the weight of the balls and the biasing of the spring assembly. However, a device by this invention is very large in size and feels like strolling around with a shopping cart on a tennis court. One can imagine that the size will also affect its cost. Furthermore, the device may not be used with existing standard bins, nor can it dispense balls automatically.

US 2004/0004097 A1 is a ball carrying portable container and dispenser directed for small diameter balls. It is designed as an elongated, cylindrical container. Plurality of balls stacked upon at each other are contained in the unit. The bottom of the unit is closed while the top has a flexible cap. In operation, a ball one at a time may be removed or extracted from under the flexible cap. A coil spring is disposed between the bottom of the container and a pusher below the stacked balls to apply a force to the balls to be moved upwardly against the flexible cap until a ball is dispensed from there, one ball at a time. However, a device by this invention may store only a limited number of balls; is adapted to use in ball games that involve small diameter balls and long distances (e.g., Golf) and may not be used in short distanced gamed (e.g., tennis), and with existing standard bins; balls are placed in the device, and dispensed therefrom on a one by one basis requiring wasting time placing balls inside the device and retrieving balls therefrom.

U.S. Pat. No. 8,177,271 B2 is an increased capacity portable retriever for collecting and dispensing tennis balls. However, it is very big in size; difficult to operate and will also give the player the above-mentioned “shopping cart” feeling on the court; needs to be manually elevated to the proper height to obviate the need for back bending; and may not be used with existing standard bins;

As can be seen, there are no devices in the prior art that (a) automatically lift the bottom of the container as it empties from balls in order to eliminate the need for bending one's back to retrieve balls; (b) utilize existing common bins or stands as structure support thus efficiently conserving material for building the device claimed herein; (c) utilize existing stands located in the area of training for hanging the container where there are no standard bins; and (d) enable the player to pick up the balls blindly from a single constant position in the basket.

### SUMMARY OF THE INVENTION

The present invention provides a removable ball dispenser for storing and dispensing sporting balls to the upper opening of the storage bins. The ball dispenser of the present invention is capable to be mounted upon any existing unadapted storage bin irrespective of the storage bin's shape. The ball dispenser is comprised of a holding platform, a plurality of hooks, elastic connector means, a plurality of hooks, and an upper horizontal frame.

Unlike various prior art devices where the mounting thereof shall on unadapted bins shall result in uncontrolled dispersal of the balls due to its need to rely on all the bin's walls for balls support, mounting a device of the present invention on such unadapted bins will contain the balls inside the device and prevent them from scattering.

For example when mounting a round shaped embodiment of the present invention on a rectangle shaped bin, at least some of the hooks of the device would cling to the bin and the elastic means would serve as “cage bars” preventing the dispersal of the balls.

Furthermore, unlike other various known devices with fully rigid designs, the device of the present invention is mountable even on storage bins that have non-cylindrical shape such as storage bin with inclined walls. This is achieved due to the elastic nature of the elastic means.

As such, the features of the invention of having, the upper horizontal frame and the holding platform, of similar surface area to each other in combination with the elastic means is a unique and inventive combination of simple components that allows to contain the balls when mounted upon irregular shaped storage bins that do not perfectly envelop the ball dispenser.

The holding platform is constructed in a way that allows holding and supporting the sporting balls utilizing the platform and said elastic connector.

The elastic connector means (e.g., springs, elastic cords, or elastic fiber cloth) are connected to the holding platform to the plurality of hooks; where said connectors elongate or shorten when filled or emptied with balls thereby lowering or raising said holding platform. The number and distribution manner of the elastic connector means, allow holding and supporting said sporting balls between them;

The plurality of hooks are connected to elastic connector means, shaped and extended such to be compatible with a variety of storage bin upper opening types and cling into the edges of the storage bin regardless to the shape of the bin's edges, and enabling the removal of the ball dispenser after usage; and

The upper horizontal frame is connected to the hooks and said elastic connector means, having a similar surface area to that of the said holding platform.

It is within the provision of the invention that the hooks that connect the device to the storage bin have a lower clamping member and together with the hook, clamp the edges of the storage bin allowing more secure grip with said bin.

It is further within the provision of the invention that the device having variable length connectors (e.g., length adjustable straps) connected between the hooks and the upper horizontal frame allowing said hooks to cling to all walls of storage bins having a shape other than a circular shape (e.g., Rectangle shaped bin), where there often varied distances between the storage bin walls.

It is further within the provision of the invention that said holding platform is constructed with an incline allowing balls to roll in a specific location within the device wherever there is a small amount of balls in the device. Thus, the user is able to retrieve a ball from the same specific place within the device.

The above function has another advantage over known art. The invention obviates the user's need to blindly search for a ball before reaching said ball, where there is a small amount of balls in the device, because the balls will not scatter sporadically within the bottom of the device.

As can be seen, the invention claimed herein has many advantages over the known art, and among them: (a) the invention automatically (elastically) lifts the bottom of the container as it empties from balls and eliminates the need for bending one's back to retrieve balls; (b) utilize any existing unadapted storage bin irrespective of its shape as structure support thus, efficiently conserving material for building the device claimed herein; (c) the device of the present invention is mountable even on storage bins that have non-cylindrical shape such as a storage bin with inclined walls; and (d) enable the player to pick up the balls blindly from a single constant position in the basket.

Other features and many attendant advantages of the invention will become more apparent upon a reading of the following detailed description together with the drawings in which like reference numerals refer to like parts throughout.

### BRIEF DESCRIPTION OF THE DRAWINGS

Embodiments and features of the present invention are described herein in conjunction with the following drawings:

FIG. 1 illustrates a perspective view of a rigid dispenser.

FIG. 1bis illustrates a perspective view of a rigid dispenser.

FIG. 2 perspective view of the emptied and an unmounted ball dispenser.

FIG. 3 illustrates a side view of the ball dispenser installed on a standard storage bin depicting the motion of the a holding platform as the springs are elastically elongated, causing a downward movement of the platform as it is filled with balls, and further as the springs return to normal state as the platform is being emptied of balls.

FIG. 4 illustrates a perspective view of the ball container installed on a round shaped standard storage bin.

FIG. 5 illustrates a perspective view of the ball container installed on a square shaped standard storage bin.

FIG. 6 illustrates a perspective view of the ball container installed on a rectangle shaped storage bin.

FIG. 6bis illustrates a side cross-section of the ball container installed on a storage bin of non-cylindrical shape with inclined walls.

FIG. 7 illustrates a side view of an embodiment of the invention involving an incline to the holding platform.

As can be seen, the holding platform is constructed with an incline allowing balls to roll in a specific location within the device wherever there is a small amount of balls in the device. Thus, the user is able to retrieve a ball from the same specific place within the device.

FIG. 8 illustrates a side view an embodiment of the invention installed on a standard storage bin.

A can be seen, the elastic connectors here are in the form of elastic fiber cloth.

FIG. 9 illustrates a side view an embodiment of the invention involving variable length connectors.

FIG. 10 illustrates a side view of the ball container installed on a rectangular shaped standard storage bin.

the device having variable length connectors, in the form of length adjustable straps connected between the hooks and the upper horizontal frame allowing said hooks to cling to all walls of storage bins having a shape other than a circular shape (e.g., Rectangle shaped bin), where there often varied distances between the storage bin walls.

### DETAILED DESCRIPTION OF THE PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

For the sake of brevity, some well-known features, methods, systems, procedures, components, circuits, and so on of the container are not described in detail. It should be apparent however, that many more modifications besides those already described are possible without departing from the inventive concepts herein. The device, therefore, is not to be restricted except in the spirit of the disclosure. Moreover, in interpreting the disclosure, all terms should be interpreted in the broadest possible manner consistent with the context.

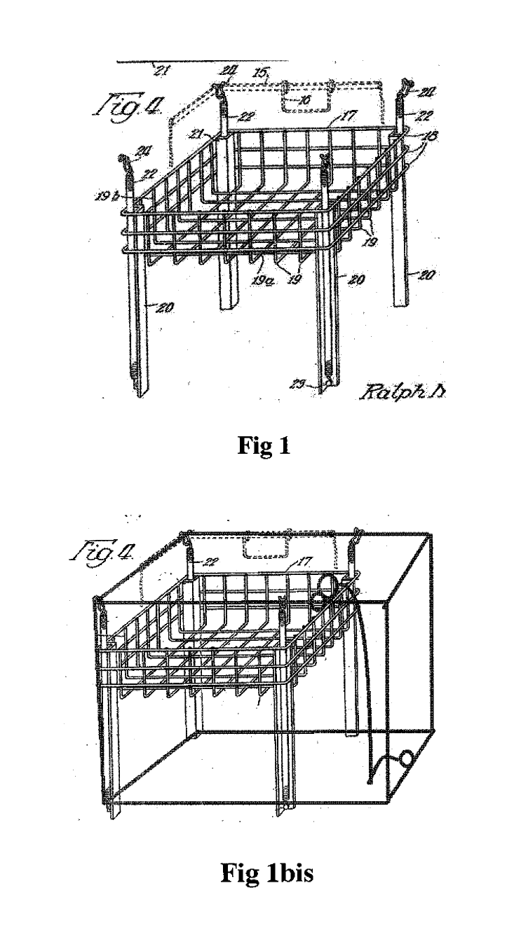

Referring initially to FIG. 1, as can be seen, the illustrated rigid device utilizes vertical walls (19b) for holding the content. It is needless to say that such a configuration results in material wastage.

Furthermore, the built-in vertical walls solution is ineffective, as said walls are of limited height. Therefore, if such a device shall be mounted on any bin other than the intended bin, the contents will start spilling from the sides. For illustration purposes, see FIG. 1bis:

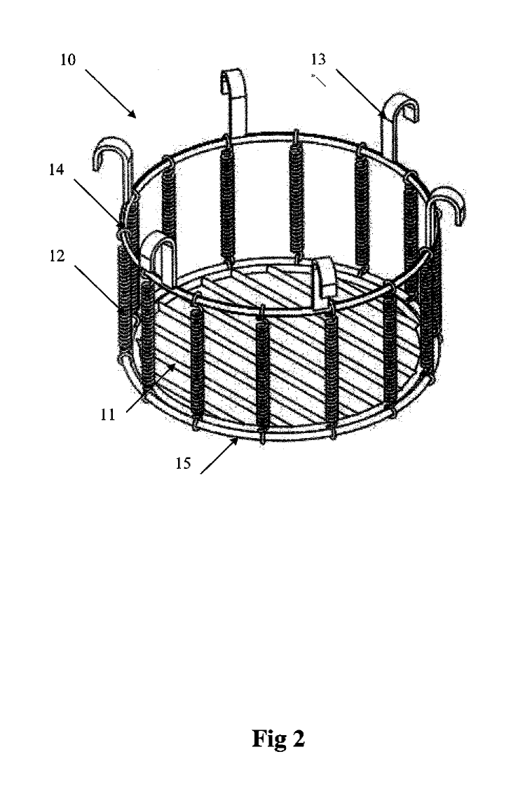

Referring to FIG. 2, illustrated is a perspective view of a preferred embodiment of the present invention where the container 10 is empty and unmounted. The ball container 10 comprising: horizontal rods 11 forming the holding platform in a way that allows holding and supporting the balls; springs 12 that are attached to the platform in the bottom; rounded hooks 13 at the top; and a circular upper horizontal frame 14.

Generally the ball container intended to contain a quantity of balls, such as tennis balls, baseballs, or any other kind of athletic balls. The container 10 includes a plurality of vertical springs 12 spaced apart, circled horizontal metal rods 11 generally constituting the holding platform. The spring assembly 12 may be connected to the platform 15 by a connector means, such as clamps screws, or other fasteners. The spring assembly 12 is operatively connected to the platform 15 for lowering or raising the platform 15. The spring assembly is designed to raise the platform 15 as it is emptied of balls and allow the platform 15 to lower as it is filled with balls.

The hooks 13 are extended from the ball dispenser itself and are of a shape such to be compatible with a variety of storage bin upper opening types having different shapes.

One of average skill in the field may choose the elastic connectors composition in the following way. Whereas the elastic connector means are springs or strings, their type is chosen for their material's elasticity modulus which may be deducted in the following method:
(a) Weighing the intended holding platform.
(b) Weighing the sporting balls that fit in the standard storage bin.
(c) Measuring the height of the standard storage bin deducting around 6 cm (eg.) from the figure.
(d) Choosing and counting the preferable number of elastic connectors to be incorporated in the embodiment.
(e) Whereas:
   F=sporting balls weight+holding platform weight; K=modulus of elasticity for each incorporated elastic connector; X=height of the standard bin minus around 6 centimeters (eg.); N=number of intended elastic connectors;

Calculating the preferable modulus of elasticity with the following formula:

F/X/N=K

It is to be mentioned that one must choose material that may elongate to achieve the height of the standard bin from its initial length of 6 Centimeters (eg.).

It is to be mentioned that the initial length of 6 Centimeters is derived from the diameter of Tennis balls. For the storage of other types of balls, a figure similar to the diameter of the intended ball should be used.

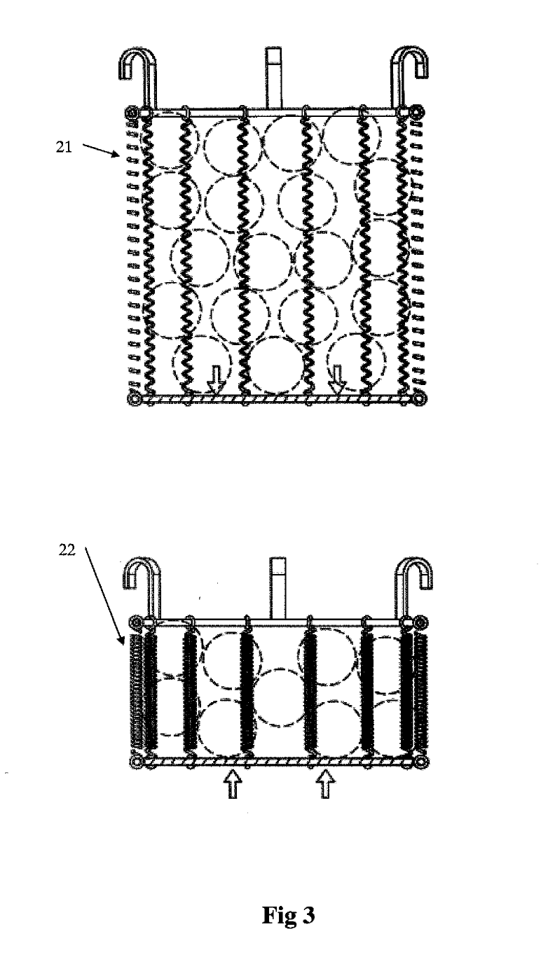

FIG. 3 illustrates the ball container installed on a standard storage bin depicting the motion of the a holding platform as the springs are elastically elongated 21, causing a downward movement of the platform as it is filled with balls, and further as the springs return to normal 22 state as the platform is being emptied of balls.

It is indicated the ball container 10 is placed within the edges of the standard bin, while the springs 12 and the platform 15 are perfectly fitted within the standard bin. It is contemplated that the springs 12 need not be directly connected to the hooks 13, so long as the spring assembly serves to bias the platform 11 automatically moving downwards as the platform 15 is filled with balls and automatically moving upwards as the platform 15 is emptied of balls in response to the weight of the balls and the biasing of the springs 12.

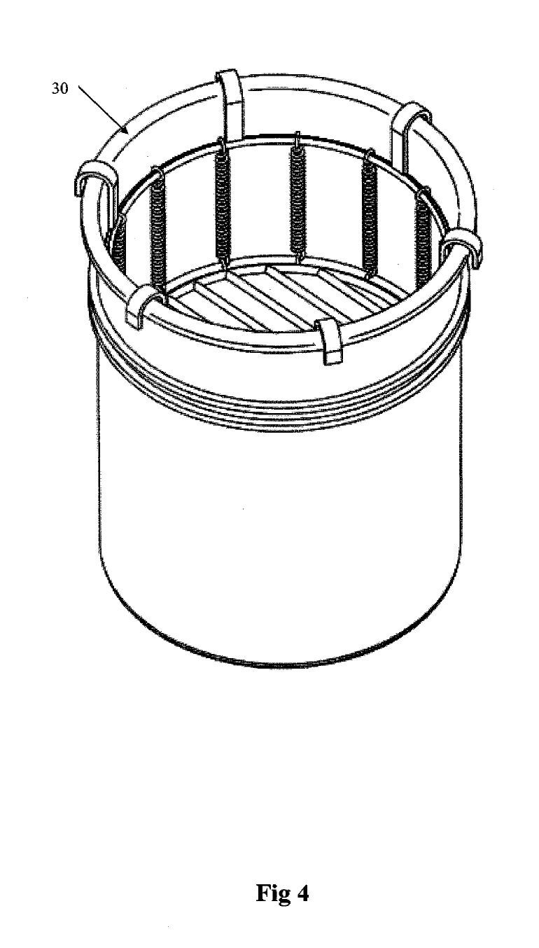

Turning now to FIG. 4 where the ball container 10 is connected to circular shaped standard bin 30 indicating the container as it enables the user to access a ball without having to bend over each time to reach down for a ball as the bin empties. Using the container, the user is able to access the balls with less delay caused by the emptying bucket. It is contemplated that the hooks can alternatively be square, with clamps, or otherwise shaped.

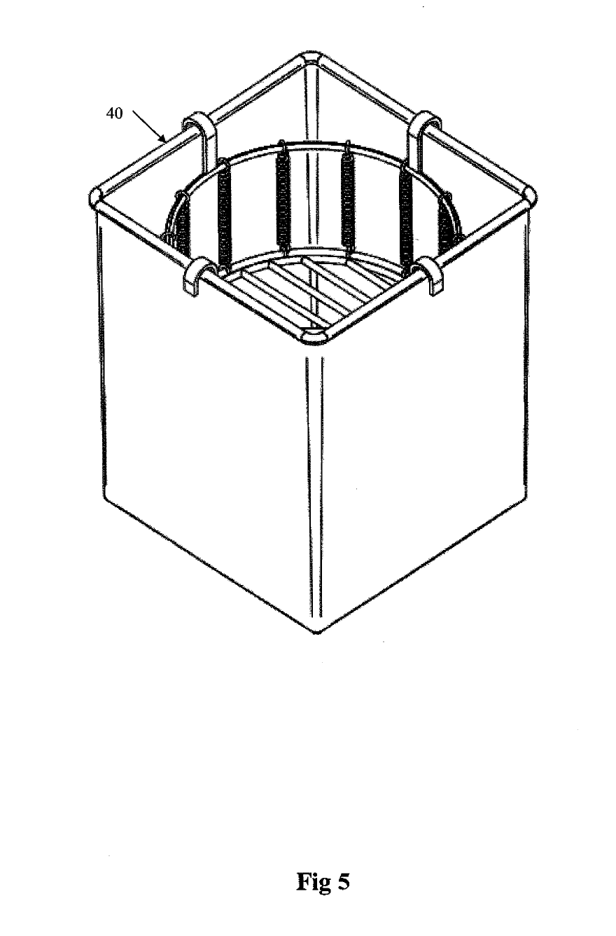

FIG. 5 illustrates a perspective view of the ball container installed on a square shaped standard storage bin 40.

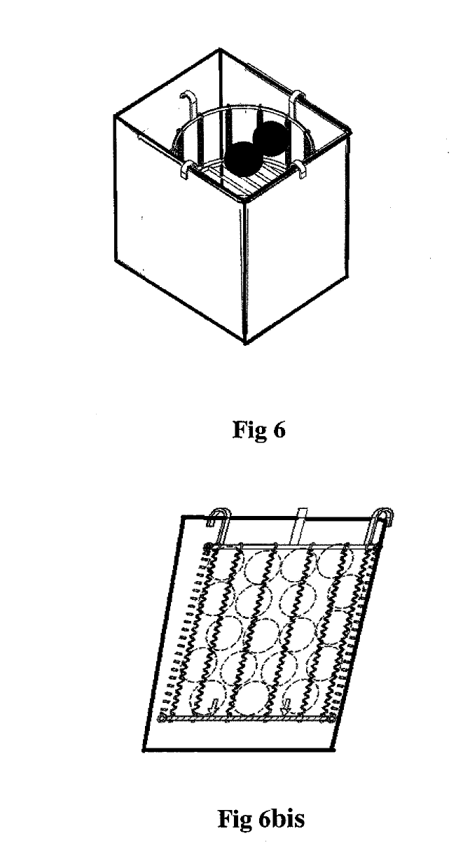

Now referring to FIG. 6. Mounting a device of the present invention on unadapted bins will keep the balls inside the device.

As can be easily seen, the holding platform and the upper horizontal frame with the elastic means form a ‘cage’, such that said elastic means serving as bars, would contain the sporting balls and prevent them from scattering even though not all the hooks are mounted on the walls.

Now referring to FIG. 6bis. As can be seen, this embodiment is mountable even on storage bins that have non-cylindrical shape such as the illustrated storage bin with inclined walls. This purpose is achieved due to the rigid nature of the upper horizontal frame and the holding platform, and the elastic nature of the elastic means that serve as a “cage” and prevent the scattering of the balls.

Thus, other known devices, embodiments of the present inventions are able to adapt to many different kinds of bin design.

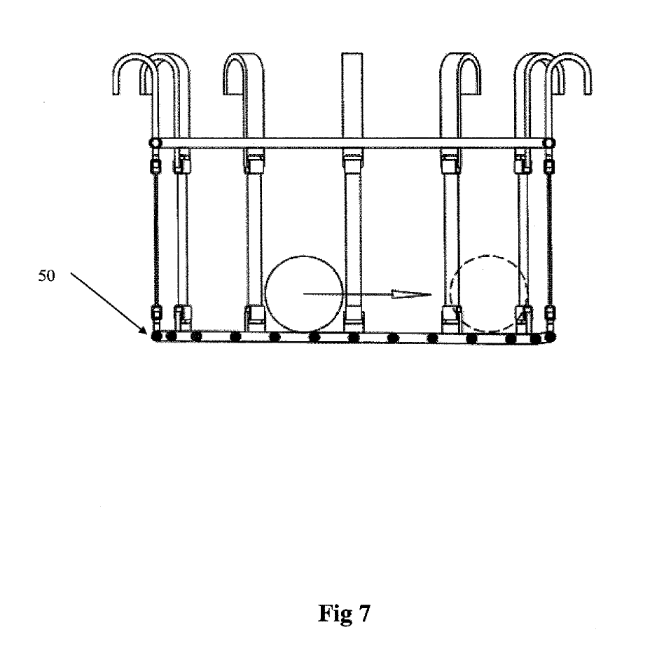

FIG. 7 illustrates a side view of an embodiment of the invention involving an incline to the holding platform.

As can be seen, the holding platform is constructed with an incline 50 allowing balls to roll in a specific location within the device wherever there is a small amount of balls in the device. Thus, the user is able to retrieve a ball from the same specific place within the device.

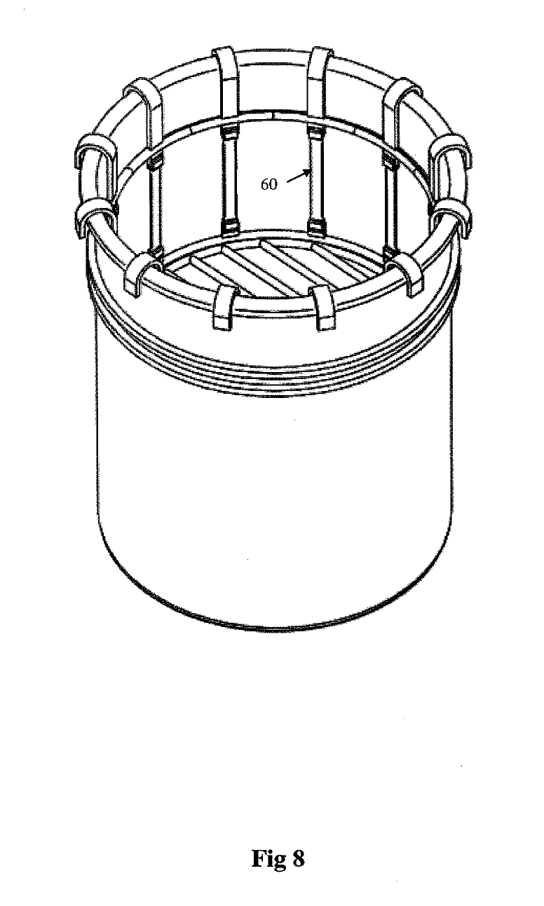

FIG. 8 illustrates a perspective view an embodiment of the invention installed on a standard storage bin.

As can be seen, the elastic connectors are formed from elastic fiber cloth 60.

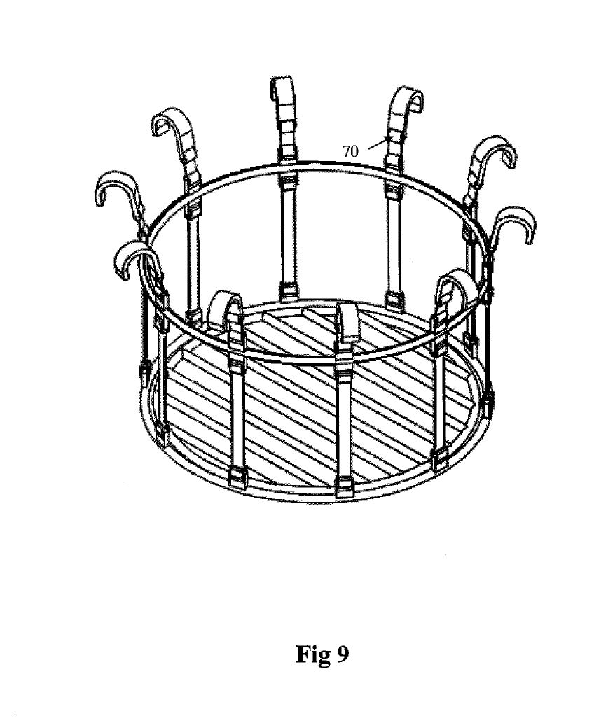

FIG. 9 illustrates a perspective view an embodiment of the invention involving variable length connectors 70.

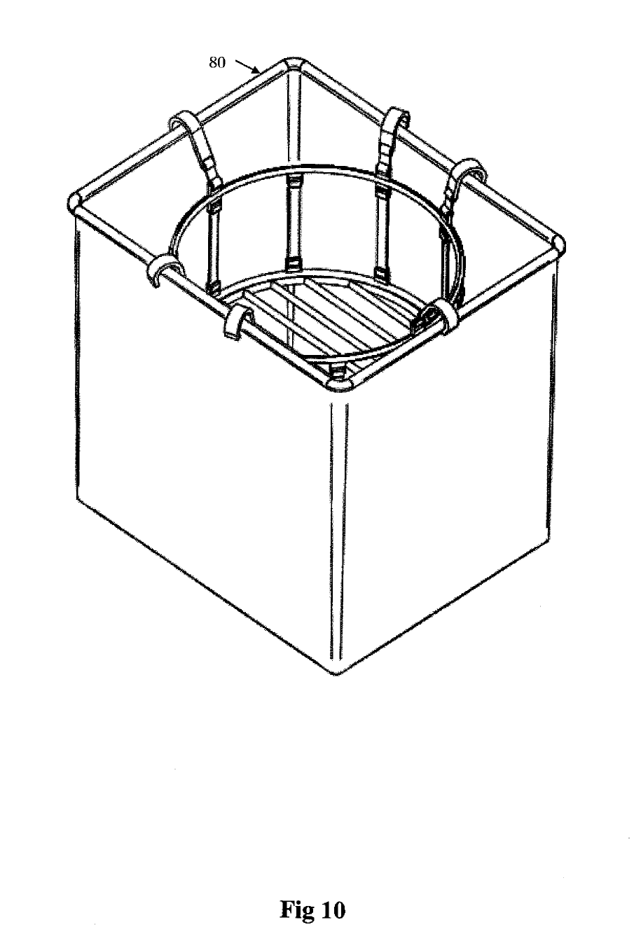

FIG. 10 illustrates a perspective view of the ball container installed on a rectangular shaped standard storage bin 80.

As can be seen, variable length connectors 70 (e.g., length adjustable straps) allow the hooks to cling to all walls of storage bins having a shape other than a circular shape (e.g., Rectangle shaped bin 80), where there are varied distances between the storage bin walls.

The foregoing description and illustrations of the embodiments of the invention have been presented for the purposes of illustration. They are not intended to be exhaustive or to limit the invention to the above descriptions in any form.

1. A ball container utilized in conjunction with existing standard storage bins for storing and dispensing sporting balls to the upper opening of the storage bins, that is comprised of:
a. a holding platform that is meant to move within the standard storage bin in a vertical axis, and is constructed in a way that allows holding and supporting said sporting balls utilizing itself and the bin's walls;
b. elastic connector means that connect the holding platform to the plurality of hooks, whereas said connectors elastically elongate and lower the platform as it being filled with balls, and further gradually return to normal state as the platform is being emptied of balls;
c. a plurality of hooks that are connected to elastic connector means and adapted to cling into the edges of the storage bin allowing the elastic elongation of said elastic connector means; and
d. an upper horizontal frame between said hooks and said elastic connector means having a similar surface area to that of the said holding platform for maintaining the vertical deformation axis of said elastic connector means. 2. A ball container utilized by hanging from a stand, for storing and dispensing sporting balls to the upper opening of the ball container, that is comprised of:
a. a holding platform that is meant to move within in a vertical axis, and is constructed in a way that allows holding and supporting said sporting balls with the elastic connector means;
b. elastic connector means that connect the holding platform to the plurality of hooks, and an upper horizontal frame, whereas said connectors elastically elongate and lower the platform as it being filled with balls, and further gradually return to normal state as the platform is being emptied of balls;
c. an upper horizontal frame between said hooks and said elastic connector means having the a similar surface area to that of the said holding platform for maintaining the vertical deformation axis of said elastic connector means;
d. a plurality of horizontal rims engulfing said elastic connector means intended to minimize the horizontal elastic deformation thereof, potentially caused by the filling of said balls.
e. a plurality of hooks that are connected to said upper horizontal frame and adapted to cling into said stand allowing the elastic elongation of said elastic connector means.

3. Any of the devices of claim 1 or 2 wherein said elastic connector means are springs.

4. Any of the devices of claim 1 or 2 wherein said elastic connector means are cords.

5. Any of the devices of claim 1 or 2 wherein said elastic connector means is an elastic fiber cloth.

6. The device of claim 1 wherein the device is adapted to be hooked on the edges of regular garbage can.

7. The device of claim 1, wherein said hooks are adapted to further clamp the edges of the storage bin allowing more secure grip with said bin.

8. The device of claim 2, wherein said hooks are adapted to further clamp the edges of stand allowing more secure grip of said stand.

9. The device of claim 1, further comprised of variable length connectors (e.g., length adjustable straps) allowing said hooks to cling to all walls of storage bins having a shape other than a circular shape (e.g., Rectangle shaped bin), where there often varied distances between the storage bin walls.

10. The device of claim 1, wherein said holding platform is constructed with an incline allowing balls to roll in a specific location within the device wherever there is a small amount of balls in the device.

11. The device of claim 2, further comprised of variable length connectors (e.g., length adjustable straps) connecting the hooks and the upper horizontal frame allowing the user to adjust the height of said upper horizontal frame to the user's hip height to obviate the need for back bending where reaching for said sporting balls.

12. A method for choosing suitable elastic connectors for devices by claim 1 or 2, whereas the elastic connector means are springs or strings, their type is chosen for their material's elasticity modulus which is deducted in the following steps:
a. Weighing the intended holding platform;
b. Weighing the sporting balls that fit in the standard storage bin;
c. Measuring the height of the standard storage bin, and deducting a certain length from the figure for the initial length of the elastic connectors;
d. Choosing and counting the preferable number of elastic connectors to be incorporated in the embodiment;
e. Whereas:
F=sporting balls weight+holding platform weight; K=modulus of elasticity for each incorporated elastic connector; X=height of the standard bin minus initial length of the elastic connectors; N=number of intended elastic connectors;
f. Calculating the preferable modulus of elasticity with the following formula: F/X/N=K;
g. Choosing material for the elastic connector means that may elongate to achieve the height of the standard bin from its initial length, without tearing the elastic connector means.

13. The method of claim 12, whereas the initial length of the elastic connectors is similar to the diameter of the ball that is intended for use with the system.
